(19) United States
(12) Patent Application Publication
(10) Pub. No.: US 2013/0251013 A1
(43) Pub. Date: Sep. 26, 2013

(54) DYNAMIC RECEIVER SWITCHING

(71) Applicant: QUALCOMM INCORPORATED, San Diego, CA (US)

(72) Inventors: Brian Clarke Banister, San Diego, CA (US); Shivratna Giri Srinivasan, San Diego, CA (US); Yuanning Yu, Santa Clara, CA (US)

(73) Assignee: QUALCOMM Incorporated, San Diego, CA (US)

(21) Appl. No.: 13/784,556

(22) Filed: Mar. 4, 2013

Related U.S. Application Data
(60) Provisional application No. 61/615,146, filed on Mar. 23, 2012.

(51) Int. Cl. H04B 1/16

(52) U.S. Cl. CPC H04B 1/16
USPC 375/224

(57) ABSTRACT

Dynamic receiver switching is implemented by a receiving device that selects a first receiver having operating characteristics associated with a first optimal operating region to decode one or more first transmissions. The receiving device then selects a second receiver to decode subsequent transmissions. The second receiver has operating characteristics and an optimal operating region that are different from those of the receiver.

### CROSS-REFERENCE TO RELATED APPLICATIONS

This application claims the benefit of U.S. Provisional Patent Application No. 61/615,146, entitled, “DYNAMIC RECEIVER SWITCHING”, filed on Mar. 23, 2012, which is expressly incorporated by reference herein in its entirety.

### BACKGROUND

1. Field

Aspects of the present disclosure relate generally to wireless communication systems, and more particularly, to dynamic receiver switching.

2. Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities.

### SUMMARY

In one aspect of the disclosure, a method of wireless communication that includes determining a channel quality of a channel associated with one or more data transmissions, selecting a first receiver to decode one or more data transmissions, wherein the first receiver is associated with higher performance at the determined channel quality than a second receiver, and selecting the second receiver to decode one or more data re-transmissions of the one or more data transmissions.

In one aspect of the disclosure, a method of wireless communication that includes determining availability of soft metrics for a data transmission, obtaining an error rate for first data transmissions over a plurality of preceding subframes, and selecting a receiver from a plurality of available receivers, at a mobile device, based, at least in part, on the availability of soft metrics and the error rate, wherein at least one receiver of the plurality of available receivers has different operating characteristics than at least another receiver of the plurality of available receivers.

In an additional aspect of the disclosure, an apparatus configured for wireless communication that includes means for determining a channel quality of a channel associated with one or more data transmissions, means for selecting a first receiver to decode one or more data transmissions, wherein the first receiver is associated with higher performance at the determined channel quality than a second receiver, and means for selecting the second receiver to decode one or more data re-transmissions of the one or more data transmissions.

In an additional aspect of the disclosure, an apparatus configured for wireless communication that includes means for determining availability of soft metrics for a data transmission, means for obtaining an error rate for first data transmissions over a plurality of preceding subframes, and means for selecting a receiver from a plurality of available receivers, at a mobile device, based, at least in part, on the availability of soft metrics and the error rate, wherein at least one receiver of the plurality of available receivers has different operating characteristics than at least another receiver of the plurality of available receivers.

In an additional aspect of the disclosure, a computer program product has a computer-readable medium having program code recorded thereon. This program code includes code for causing at least one computer to determining a channel quality of a channel associated with one or more data transmissions, code for causing at least one computer to select a first receiver to decode one or more data transmissions, wherein the first receiver is associated with higher performance at the determined channel quality than a second receiver, and code for causing at least one computer to select the second receiver to decode one or more data re-transmissions of the one or more data transmissions.

In an additional aspect of the disclosure, a computer program product has a computer-readable medium having program code recorded thereon. This program code includes code for causing at least one computer to determine availability of soft metrics for a data transmission, code for causing at least one computer to obtain an error rate for first data transmissions over a plurality of preceding subframes, and code for causing at least one computer to select a receiver from a plurality of available receivers, at a mobile device, based, at least in part, on the availability of soft metrics and the error rate, wherein at least one receiver of the plurality of available receivers has different operating characteristics than at least another receiver of the plurality of available receivers.

In an additional aspect of the disclosure, an apparatus includes at least one processor and a memory coupled to the processor. The processor is configured to determining a channel quality of a channel associated with one or more data transmissions, to select a first receiver to decode one or more data transmissions, wherein the first receiver is associated with higher performance at the determined channel quality than a second receiver, and to select the second receiver to decode one or more data re-transmissions of the one or more data transmissions.

In an additional aspect of the disclosure, an apparatus includes at least one processor and a memory coupled to the processor. The processor is configured to determine availability of soft metrics for a data transmission, to obtain an error rate for first data transmissions over a plurality of preceding subframes, and to select a receiver from a plurality of available receivers, at a mobile device, based, at least in part, on the availability of soft metrics and the error rate, wherein at least one receiver of the plurality of available receivers has different operating characteristics than at least another receiver of the plurality of available receivers.

### BRIEF DESCRIPTION OF THE DRAWINGS

FIG. 1 is a block diagram illustrating an example of a mobile communication system.

FIG. 2 is a block diagram illustrating a design of a base station/eNB and a UE configured according to one aspect of the present disclosure.

FIG. 3 is a functional block diagram illustrating example blocks executed to implement one aspect of the present disclosure.

FIG. 4 is a block diagram illustrating a receiving device configured according to one aspect of the present disclosure.

FIG. 5 is a call flow diagram illustrating example communication between a UE and an eNB according to one aspect of the present disclosure.

FIG. 6 is a functional block diagram illustrating example blocks executed to implement one aspect of the present disclosure.

FIG. 7 is a functional block diagram illustrating example blocks executed to implement one aspect of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The techniques described herein may be used for various wireless communication networks such as CDMA, TDMA, FDMA, OFDMA, SC-FDMA and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. For clarity, certain aspects of the techniques are described below for LTE or LTE-A (together referred to in the alternative as “LTE/-A”) and use such LTE/-A terminology in much of the description below.

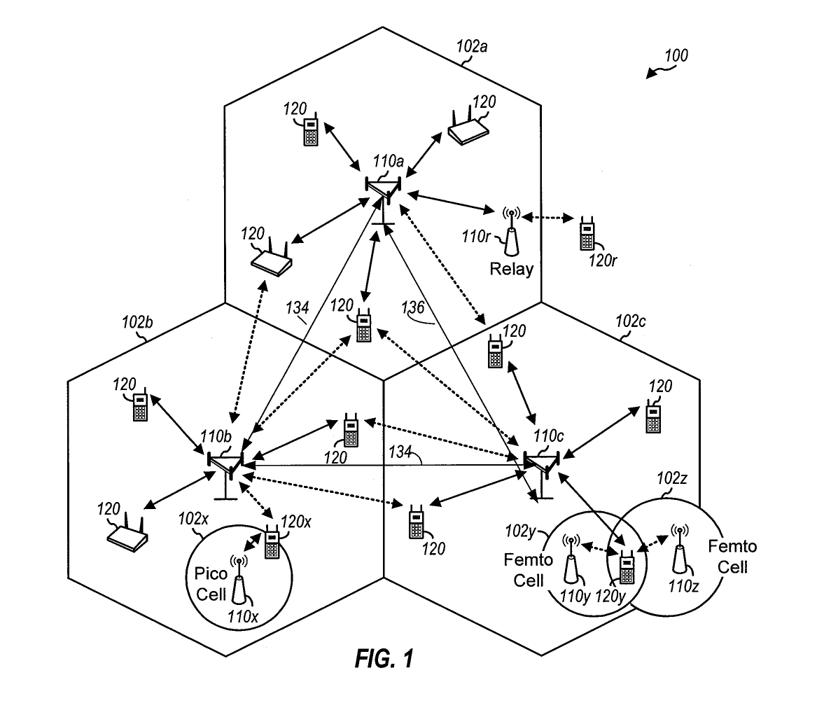

FIG. 1 shows a wireless network 100 for communication, which may be an LTE-A network. The wireless network 100 includes a number of evolved node Bs (eNBs) 110 and other network entities. An eNB may be a station that communicates with the UEs and may also be referred to as a base station, a node B, an access point, and the like. Each eNB 110 may provide communication coverage for a particular geographic area. In 3GPP, the term “cell” can refer to this particular geographic coverage area of an eNB and/or an eNB subsystem serving the coverage area, depending on the context in which the term is used.

An eNB may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. In the example shown in FIG. 1, the eNBs 110a, 110b and 110c are macro eNBs for the macro cells 102a, 102b and 102c, respectively. The eNB 110x is a pico eNB for a pico cell 102x. And, the eNBs 110y and 110z are femto eNBs for the femto cells 102y and 102z, respectively. An eNB may support one or multiple (e.g., two, three, four, and the like) cells.

The wireless network 100 also includes relay stations. A relay station is a station that receives a transmission of data and/or other information from an upstream station (e.g., an eNB, a UE, or the like) and sends a transmission of the data and/or other information to a downstream station (e.g., another UE, another eNB, or the like). A relay station may also be a UE that relays transmissions for other UEs. In the example shown in FIG. 1, a relay station 110r may communicate with the eNB 110a and a UE 120r, in which the relay station 110r acts as a relay between the two network elements (the eNB 110a and the UE 120r) in order to facilitate communication between them. A relay station may also be referred to as a relay eNB, a relay, and the like.

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

The UEs 120 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE/-A utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 72, 180, 300, 600, 900, and 1200 for a corresponding system bandwidth of 1.4, 3, 5, 10, 15, or 20 megahertz (MHz), respectively. The system bandwidth may also be partitioned into sub-bands. For example, a sub-band may cover 1.08 MHz, and there may be 1, 2, 4, 8 or 16 sub-bands for a corresponding system bandwidth of 1.4, 3, 5, 10, 15, or 20 MHz, respectively.

The wireless network 100 uses the diverse set of eNBs 110 (i.e., macro eNBs, pico eNBs, femto eNBs, and relays) to improve the spectral efficiency of the system per unit area. Because the wireless network 100 uses such different eNBs for its spectral coverage, it may also be referred to as a heterogeneous network. The macro eNBs 110a-c are usually carefully planned and placed by the provider of the wireless network 100. The macro eNBs 110a-c generally transmit at high power levels (e.g., 5 W-40 W). The pico eNB 110x and the relay station 110r, which generally transmit at substantially lower power levels (e.g., 100 mW-2 W), may be deployed in a relatively unplanned manner to eliminate coverage holes in the coverage area provided by the macro eNBs 110a-c and improve capacity in the hot spots. The femto eNBs 110y-z, which are typically deployed independently from the wireless network 100 may, nonetheless, be incorporated into the coverage area of the wireless network 100 either as a potential access point to the wireless network 100, if authorized by their administrator(s), or at least as an active and aware eNB that may communicate with the other eNBs 110 of the wireless network 100 to perform resource coordination and coordination of interference management. The femto eNBs 110y-z typically also transmit at substantially lower power levels (e.g., 100 mW-200 mW) than the macro eNBs 110a-c.

Channel conditions experienced by UEs 120 may vary significantly throughout wireless network 100. A UE 120 may detect channel conditions with various measurements such as a signal-to-noise ratio (SNR), signal-to-interference-plus-noise ratio (SINR), carrier-to-interference-plus-noise ratio (CINR), etc. Information about the channel conditions, also referred to as channel state information (CSI), may be sent to a serving base station 110 and used to determine a transmission mode and other communication parameters. A hybrid automatic repeat request (HARQ) mechanism may also be used to manage the transmission and re-transmissions of data between eNBs 110 and UEs 120.

As described herein, it may be advantageous for a UE 120 to select different receivers depending upon channel conditions, transmission modes, retransmission rates, and other factors. In one aspect, a UE 120 may use a different receiver for demodulation in a high SNR environment than it uses in a low SNR environment. An initial receiver may be selected according to one or more predetermined performance characteristics. The UE 120 may then be vary its receiver dynamically (i.e. subframe-to-subframe) based on additional criteria such as CSI, MCS (modulation and coding scheme), a number of retransmissions, etc. In one particular example, each UE 120 may include a first receiver having a Linear Minimum Mean Square Error (LMMSE) de-mapper engine and a second receiver having an MLD de-mapper engine. The MLD receiver may be selected for MIMO demodulation in high SNR environments whereas the LMMSE receiver may be utilized in low SNR environments.

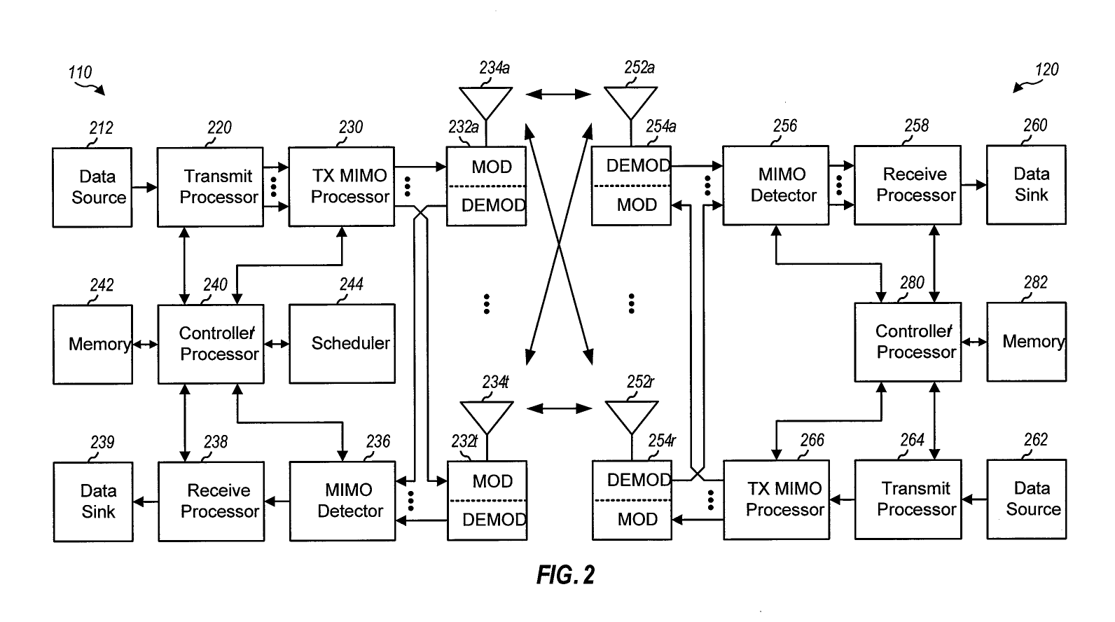

FIG. 2 shows a block diagram of a design of a base station/eNB 110 and a UE 120, which may be one of the base stations/eNBs and one of the UEs in FIG. 1. For a restricted association scenario, the eNB 110 may be the macro eNB 110c in FIG. 1, and the UE 120 may be the UE 120y. The eNB 110 may also be a base station of some other type. The eNB 110 may be equipped with antennas 234a through 234t, and the UE 120 may be equipped with antennas 252a through 252r.

At the eNB 110, a transmit processor 220 may receive data from a data source 212 and control information from a controller/processor 240. The control information may be for the physical broadcast channel (PBCH), physical control format indicator channel (PCFICH), physical hybrid automated repeat request channel (PHICH), physical downlink control channel (PDCCH), etc. The data may be for the physical downlink shared channel (PDSCH), etc. The transmit processor 220 may process (e.g., encode and symbol map) the data and control information to obtain data symbols and control symbols, respectively. The transmit processor 220 may also generate reference symbols, e.g., for the primary synchronization signal (PSS), secondary synchronization signal (SSS), and cell-specific or “common” reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 120, the antennas 252a through 252r may receive the downlink signals from the eNB 110 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280. Receive processor 258 may support different types of demodulation and dynamic switching according to channel conditions, performance characteristics, and the like.

On the uplink, at the UE 120, a transmit processor 264 may receive and process data (e.g., for the PUSCH) from a data source 262 and control information (e.g., for the PUCCH) from the controller/processor 280. The transmit processor 264 may also generate reference symbols for a reference signal. The symbols from the transmit processor 264 may be precoded by a TX MIMO processor 266 if applicable, further processed by the demodulators 254a through 254r (e.g., for SC-FDM, etc.), and transmitted to the eNB 110. At the eNB 110, the uplink signals from the UE 120 may be received by the antennas 234, processed by the modulators 232, detected by a MIMO detector 236 if applicable, and further processed by a receive processor 238 to obtain decoded data and control information sent by the UE 120. The processor 238 may provide the decoded data to a data sink 239 and the decoded control information to the controller/processor 240.

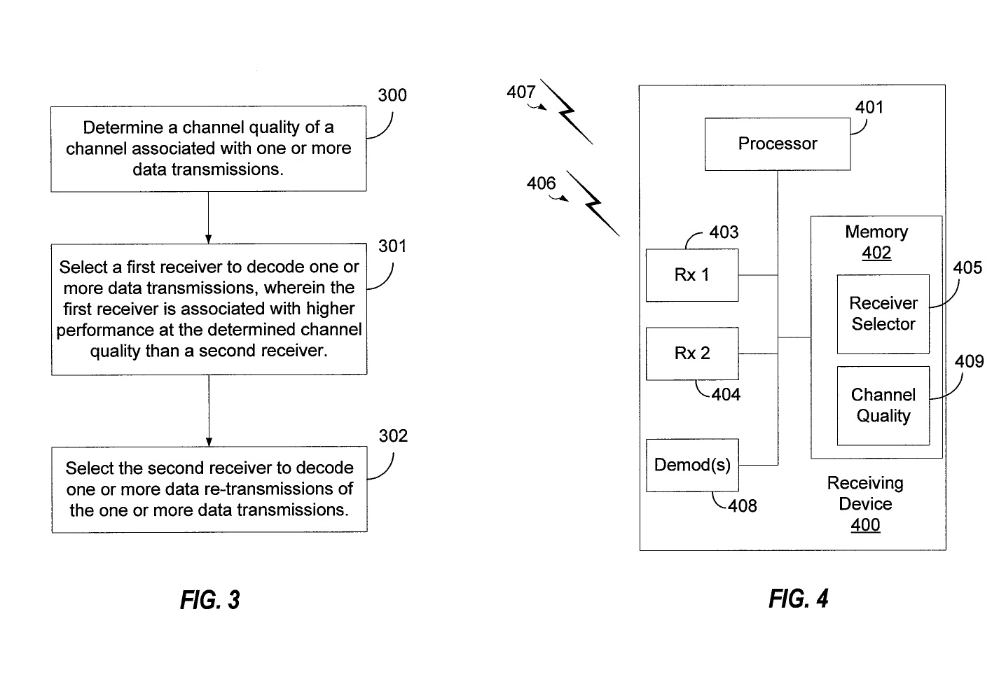

The controllers/processors 240 and 280 may direct the operation at the eNB 110 and the UE 120, respectively. The controller/processor 240 and/or other processors and modules at the eNB 110 may perform or direct the execution of various processes for the techniques described herein. The controllers/processor 280 and/or other processors and modules at the UE 120 may also perform or direct the execution of the functional blocks illustrated in FIGS. 3 and 6-7, and/or other processes for the techniques described herein. The memories 242 and 282 may store data and program codes for the eNB 110 and the UE 120, respectively. A scheduler 244 may schedule UEs for data transmission on the downlink and/or uplink.

For MIMO signaling, a receiving device will have multiple receivers. Dynamic switching of these multiple receivers may be used to increase the efficiency of transmission decoding. FIG. 3 is a functional block diagram illustrating example blocks executed to implement one aspect of the present disclosure. In one aspect, blocks 300-302 may be performed by a receive processor 258 or a combination of the elements shown for UE 120 in FIG. 2. At block 300, a channel quality is determined for a channel associated with one or more data transmissions. With reference to FIG. 4, for purposes of illustrating an example implementation of the operations illustrated in blocks 300-302, data transmission signals 406 may be received by receiving device 400 at any of receivers Rx 1 403 or Rx 2 404. Receivers Rx 1 and Rx 2 may include a variety of receiver-types, including a maximum log map (MLM), such as a maximum likelihood detector (MLD) receiver, a means square-based receiver, such as a linear minimum means square error (LMMSE) receiver, a sphere decoding receiver, and the like. Each type of receiver may have an operating region over which it produces more reliable results. Under control of processor 401, channel quality logic 409, stored in memory 402, is executed. The executing environment of channel quality logic 409 is able to analyze and determine the quality of the downlink channels. The combination of these acts and components may provide means for determining a channel quality of a channel associated with one or more data transmissions.

At block 301, a first receiver to decode one or more data transmissions, wherein the first receiver is associated with higher performance at the determined channel quality than a second receiver. For example, processor 401, at receiving device 400, executes receiver selector logic 405, stored in memory 402. The operating environment of receiver selector logic 405 selects whichever of receiver 1 (Rx 1) 403 or receiver 2 (Rx 2) 404 that is associated with higher performance at the determined channel quality. In operation, an LMMSE receiver has been shown to work better when the signal-to-noise ratio (SNR) is low. Conversely, an MLD receiver has been shown to work better when the SNR is high. However, based on a given channel quality indicator (CQI) the MLD receiver may have a potential available MCS assignment that would support a higher throughput or better performance, should the decoding operation successfully decode received data transmissions. Thus, if Rx 1 403 is an MLD-type receiver, while Rx 2 404 is an LMMSE-type receiver, then receiving device 400 will select Rx 1 403. Receiving device 400 then uses Rx 1 403 to decode data transmissions 406. The combination of these acts and components may provide means for selecting a first receiver to decode one or more data transmissions, wherein the first receiver is associated with higher performance at the determined channel quality than a second receiver.

At block 302, the second receiver is selected to decode one or more data re-transmissions of the data transmissions. For example, when Rx 1 403, of receiving device 400, fails to properly decode data transmissions 406, the operating environment of receiver selector logic 405, executed by processor 401, operates to select Rx 2 404 to receive and decode data re-transmissions 407. As noted in the description above, Rx 2 404 is an LMMSE-type receiver, for purposes of the described example, that generally works better when SNR is low. Moreover, receiving device 400 will have soft metrics produced by the de-mapper of Rx 1 403 in the first attempt to decode data transmissions 406. While Rx 2 404 operates better at low SNR, it will also have a very high decode success rate when using the soft metrics to conduct HARQ combining. The combination of these acts and components may provide means for selecting the second receiver to decode one or more data re-transmissions of the one or more data transmissions.

It should be noted that, for purposes of this disclosure, SNR includes other noise measurement ratios, such as signal-to-interference-plus-noise (SINR), carrier-to-interference-plus-noise (CINR), and the like. The various aspects of the present disclosure are not limited to a single noise measurement.

As referenced above, FIG. 4 is a block diagram illustrating a receiving device 400 configured according to one aspect of the present disclosure. The receiving device 400 may be a UE, similar to the UEs 120 illustrated in FIGS. 1 and 2. In alternative aspects, the receiving device 400 may be an eNB, similar to the eNBs 110 illustrated in FIGS. 1 and 2. The process and structure defining the various aspects of the present disclosure are similar for both UEs and eNBs in their operation as a receiving device of signals.

Receiving device 400 includes a processor 401 which controls the various functions and features of the receiving device 400. Accessing memory 402, processor 401 may execute program code or logic to operate receiving device 400. Receiving device 400 also includes multiple receivers, Rx 1 403 and Rx 2 404. Receivers Rx 1 and Rx 2 have different operating characteristics and may, therefore, be of various different types, such as an MLM receiver, an MLD receiver, an LMMSE receiver, a sphere decoding receiver, and the like, as noted above. Each of receivers Rx 1-403 and Rx 2-404 may also have different optimal operating regions in which each one works best.

Receiver selector logic 405 is stored in memory 402 of receiver device 400. When executed by the processor 401, the receiver selector logic 405 makes a selection of one of receivers Rx 1-403 and Rx 2-404 to perform decoding of a received signal in a subframe. Receiver selector logic 405 may be configured to select such receivers in various different ways. In one such operational example, receiver Rx 1-403 is an MLD-type receiver that has an optimal operating region in a high-SNR environment, while receiver Rx 2-404 is an LMMSE-type receiver that has an optimal operating region in a low-SNR environment. In the first operational example, receiver selector logic 405 determines that the first transmission 406 will be decoded by receiver Rx 1-403, as the first transmission 406 may generally occur in a higher SNR environment. During subsequent HARQ re-transmissions 407, the receiver selector logic 405 switches to decoding the re-transmissions 407 using receiver 2-404. The subsequent HARQ re-transmissions 407 may generally occur in a lower SNR environment. Thus, switching to receiver Rx 2-404, which, in the described first operational example, is an LMMSE-type receiver, should operate better at the lower SNR. Not only producing better results that an MLD-type receiver at the given SNR environment, but also displaying more efficient power management. The decoding results from receivers Rx 1-403 and Rx 2-404 are provided as input to the back-end of demodulator(s) 408 for further processing of the received signals.

In general operation of a receiving device, a soft de-mapper engine may be used to produce final soft metrics in terms of bitwise log likelihood ratios (LLRs), which are then provided as an input to a demodulator back end of the receiving device. Two candidates for soft de-mapper are: (1) an LMMSE de-mapper/receiver, which is a simple linear vector weighted estimator; and (2) an MLD de-mapper/receiver, which is a sub-optimal maximum log receiver suited for MIMO demodulation at high SNR regimes.

In MIMO operations, a hard decision is made regarding which of the two de-mappers/receivers will be used during a subframe. In comparison, a MLD receiver generally works better than a LMMSE receiver at high SNR regimes. In contrast, an LMMSE receiver works better at low SNR regimes, especially when HARQ re-transmissions are involved. Moreover, LMMSE receivers are generally more power efficient.

From the comparison of LMMSE receivers and MLD receiver for MIMO operations, an observation may be made that the LMMSE and MLD curves diverge around half peak throughput, which suggests that the LMMSE receiver failed to decode the first transmission at high SNR range, where the MLD receiver succeeds. Thus, in the simplest aspect of the various aspects of the present disclosure, in switching between an LMMSE receiver and an MLD receiver, the receiving device first selects the MLD receiver to decode the first transmission and then falls back to the LMMSE for all the following transmissions.

During retransmissions, the receiver device 400 will retain the LLRs produced by the MLD soft de-mapper engine. Thus, in additional to the retransmitted signals, the receiver device 400 will have the LLRs, which will allow for a HARQ-combining decoding process that increases the likelihood of successfully decoding the retransmitted signal. In operation, on retransmissions, the MLD-type and LMMSE-type receivers may both have a high percentage success rate for decoding the retransmitted data. Accordingly, power consumption at the receiving device 400 may be improved by switching to the LMMSE-type receiver, which generally consumes less power, while still achieving a high decode success rate in the retransmission.

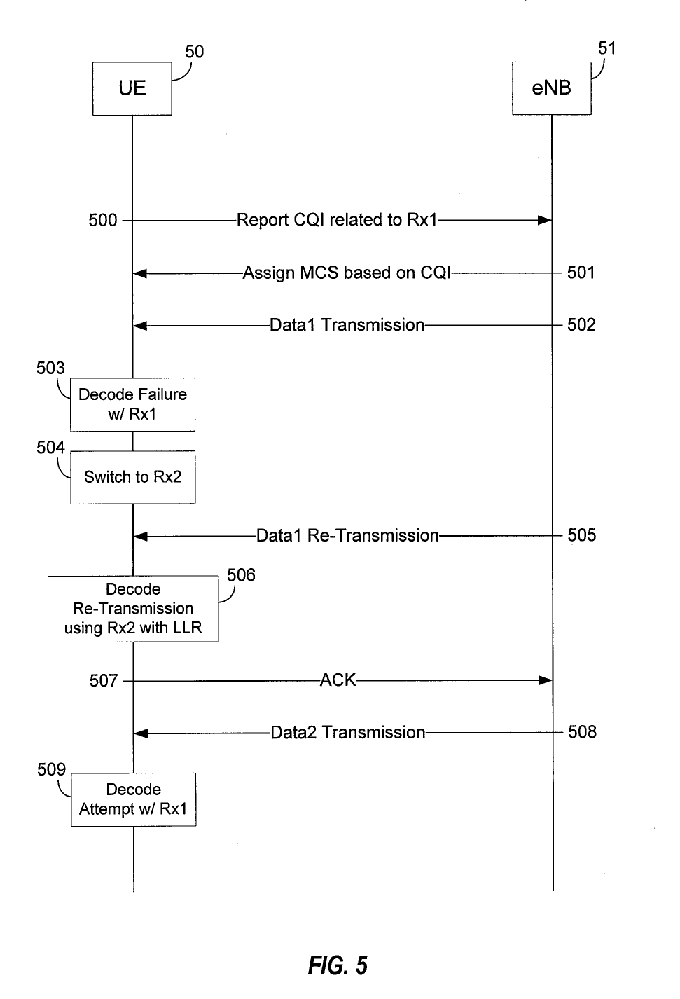

FIG. 5 is a call flow diagram illustrating communication interaction between an eNB 51 and a UE 50 configured according to one aspect of the present disclosure. UE 50 includes two different receivers Rx1, which is an advanced receiver, such as an MLM or MLD-type receiver, and Rx2, which may be a less complex receiver, such as an LMMSE-type receiver. Rx1 may have better operational performance at higher SNR, while Rx2 may have better operational performance at lower SNR. Additionally, the higher performance characteristics of Rx1 allow for UE 50 to report a CQI to eNB 51 that would allow eNB 51 to assign a higher MCS, which could result in a better performance or higher throughput when Rx1 is used. With the potentially higher MCS and potentially better performance/throughput, UE 50 initially selects to use Rx1 for decoding data transmissions. At 500, UE reports to eNB 51 a CQI value that is associated with the use of Rx1. Based on the CQI value, eNB 51, at 501, assigns an MCS value to UE 500. UE 500 then sets up operation based on the assigned MCS value.

At 502, data transmissions begin with a first transmission of data to UE 50. In the example of operation illustrated in FIG. 5, UE 50 fails to properly decode the data transmission, at 503, using Rx1. In response to the failure to decode the data transmission, at 504, UE 50 switches operation to Rx2. A re-transmission of the data is then sent by eNB 51, at 505. UE 50, using Rx2, now decodes the re-transmission at 506. The decoding process of Rx2 of the re-transmitted data includes HARQ combining, by using the LLRs that were generated by Rx2 during the failed decoding attempt at 503. With a successful decoding of the re-transmission, UE 50 transmits an acknowledgement at 507 to eNB 51. The next set of data is then transmitted by eNB 51 at 508. With the acknowledgement transmitted, UE 50 will switch back to Rx1 for decoding first transmissions, such as at 509, in attempting to decode the next set of data sent at 508.

It should be noted that, in alternative operations of UE 50, the first transmission of data at 502 may be successfully decoded by Rx1 at 503. When the first transmissions are successfully decoded, UE 50 will maintain selection of Rx1 for further data transmissions. When Rx1 fails to decode a subsequent first transmission of data, such as at 503, it will then selected to switch to Rx2, as at 504, for the retransmissions of data and subsequent first transmissions.

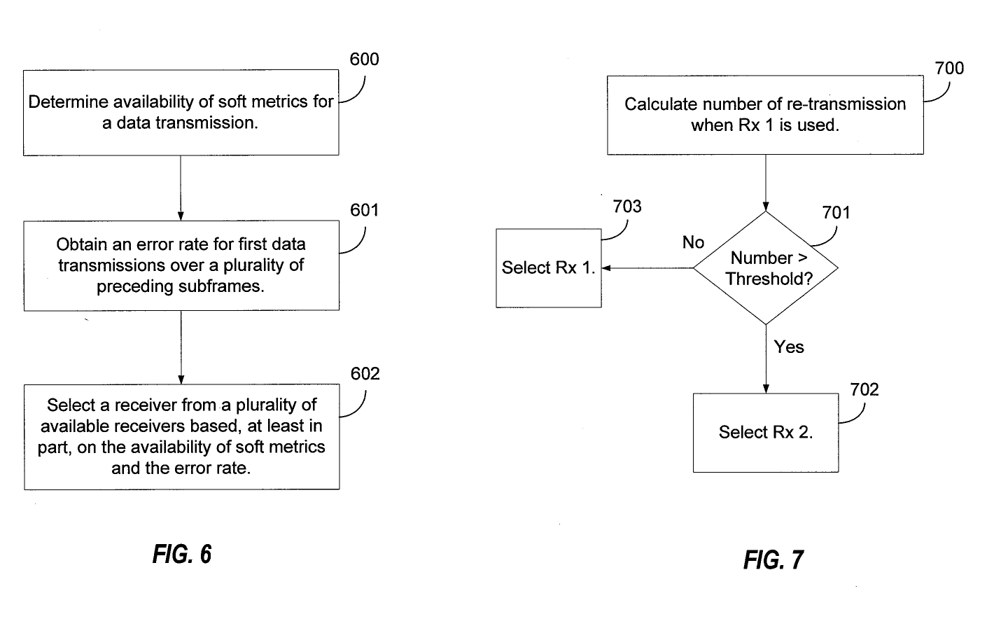

FIG. 6 is a functional block diagram illustrating example blocks executed to implement one aspect of the present disclosure. At block 600, availability of soft metrics for a data transmission are determined. As noted above, soft metrics, such as LLRs, are produced by the soft de-mapper engines used while attempting to decode data transmissions. During an unsuccessful attempt to decode data transmissions, these soft metrics are still produced. If they are present and related to data transmissions that are being received, the receiving device will know that the data transmissions are. HARQ re-transmissions. With reference to FIG. 4, receiving device 400, under control of processor 401, accesses memory 402 to determine whether any soft metrics have been saved that were produced by either of Rx 1 403 or Rx 2 404 and used as input to demodulators 408. The combination of these acts and components may provide means for determining availability of soft metrics for a data transmission.

At block 601, an error rate is obtained for first data transmissions over a plurality of preceding subframes. For example, receiving device 400 may save information in memory 402, under control of processor 401, whenever a data transmission received at Rx 1 403 is unsuccessfully decoded demodulators 408. This information may indicate that Rx 1 403 is not a suitable receiver choice for the particular area in which receiving device 400 is currently located. The combination of these acts and components may provide means for obtaining an error rate for first data transmissions over a plurality of preceding subframes.

At block 602, a receiver is selected by a receiving device from multiple available receivers, based, at least in part, on the availability of soft metrics and the error rate. The multiple available receivers at the receiving device include at least one receiver that has different operating characteristics than another of the available receivers. For example, receiving device 400, after checking memory 402 for both soft metrics associated with the data transmissions and an error rate experienced over a window of preceding first data transmissions or a count of the number of required HARQ re-transmissions over specific period of time, the receiving device 400, under control of processor 401 executing receiver selector logic 405, stored in memory 402, will select the appropriate one of receivers Rx 1 403 or Rx 2 404.

In example aspects where Rx 1 403 is an MLD-type receiver and Rx 2 is an LMMSE-type receiver, if receiving device 400 finds soft metrics stored in memory 402, processor 401 will select Rx 2 404 for receiving the data transmissions, which will be HARQ re-transmissions, as the soft metrics will have been created at previous decoding attempts. Receiving device 400 will also select Rx 2 404 if no soft metrics are found in memory 402, but the error rate in memory 402 indicates that decoding attempts of first data transmissions using Rx 1 403 have been unsuccessful at a rate higher than a particular threshold. In such aspects, receiving device determines it is better to initially select Rx 2 404. When receiving device 400 does not find soft metrics in memory 402 and the error rate does not exceed the threshold, receiving device 400 will select Rx 1 403 for receiving the first data transmissions. The combination of these acts and components may provide means for selecting a receiver from a plurality of available receivers, at a mobile device, based, at least in part, on the availability of soft metrics and the error rate, wherein at least one receiver of the plurality of available receivers has different operating characteristics than at least another receiver of the plurality of available receivers.

With reference to the error rate identified in the example aspect of FIG. 6, this error rate information may be developed by the receiving device, such as a UE or by an eNB tracking the performance of a receiver UE to aid in the receiver selection process. FIG. 7 is a functional block diagram illustrating example blocks executed to implement one aspect of the present disclosure. At block 700, the receiving device calculates or determines the number of re-transmissions that occur when the first receiver, Rx1, is used. That number of re-transmissions may provide the error rate of Rx1. A determination is made, at block 701, whether the number of re-transmissions exceeds a given threshold. If so, then, the other receiver, Rx2, is selected for decoding the subsequent transmissions. If the number of re-transmissions does not exceed the threshold, however, then, at block 703, Rx1 is selected to decode the subsequent transmissions.

The functional blocks and modules in FIGS. 3 and 6-7 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
determining a channel quality of a channel associated with one or more data transmissions;
selecting a first receiver to decode one or more data transmissions, wherein the first receiver is associated with higher performance at the determined channel quality than a second receiver; and
selecting the second receiver to decode one or more data re-transmissions of the one or more data transmissions.

2. The method of claim 1, wherein the first receiver has first operating characteristics associated with a first optimal operating region and the second receiver has second operating characteristics associated with a second optimal operating region, wherein the first optimal operating region is different from the second optimal operating region.

3. The method of claim 2, wherein the first optimal operating region comprises one of: a high signal to noise ratio and a low signal to noise ratio; and
the second optimal operating region comprises one of the low signal to noise ratio, when the first optimal operating region is the high signal to noise ratio, and the high signal to noise ratio, when the first optimal operating region is the low signal to noise ratio.

4. The method of claim 1, further comprising:
determining an average number of data re-transmissions when the first receiver is selected to decode the one or more data transmissions; and
selecting the second receiver to decode the one or more data transmissions in response to the average number of data re-transmissions exceeding a threshold.

5. The method of claim 1, wherein the first receiver comprises a maximum likelihood detector (MLD) receiver and the second receiver comprises a linear minimum mean square error (LMMSE) receiver.

6. The method of claim 1, wherein the selecting the first and second receivers occurs during multiple input, multiple output (MIMO) wireless communication.

7. A method of wireless communication, comprising:
determining availability of soft metrics for a data transmission;
obtaining an error rate for first data transmissions over a plurality of preceding subframes; and
selecting a receiver from a plurality of available receivers, at a mobile device, based, at least in part, on the availability of soft metrics and the error rate, wherein at least one receiver of the plurality of available receivers has different operating characteristics than at least another receiver of the plurality of available receivers.

8. The method of claim 7, wherein the operating characteristics of the selected receiver includes a first optimal operating region in a high signal to noise ratio when soft metrics are not available and the error rate is below a threshold.

9. The method of claim 7, wherein the operating characteristics of the selected receiver includes a second optimal operating region in a low signal to noise ratio when soft metrics are available.

10. The method of claim 9, further comprising:
decoding a re-transmission of the data transmission by the selected receiver using the soft metrics.

11. The method of claim 7, wherein the operating characteristics of the selected receiver includes a second optimal operating region in a low signal to noise ratio when the error rate exceeds a threshold.

12. The method of claim 7, wherein the plurality of available receivers includes at least a maximum likelihood detector (MLD) receiver and a linear minimum mean square error (LMMSE) receiver.

13. The method of claim 7, wherein the soft metrics include log likelihood ratios (LLRs).

14. An apparatus configured for wireless communication, comprising:
means for determining a channel quality of a channel associated with one or more data transmissions;
means for selecting a first receiver to decode one or more data transmissions, wherein the first receiver is associated with higher performance at the determined channel quality than a second receiver; and
means for selecting the second receiver to decode one or more data re-transmissions of the one or more data transmissions.

15. The apparatus of claim 14, wherein the first receiver has first operating characteristics associated with a first optimal operating region and the second receiver has second operating characteristics associated with a second optimal operating region, wherein the first optimal operating region is different from the second optimal operating region.

16. The apparatus of claim 15, wherein the first optimal operating region comprises one of: a high signal to noise ratio and a low signal to noise ratio; and
the second optimal operating region comprises one of the low signal to noise ratio, when the first optimal operating region is the high signal to noise ratio, and the high signal to noise ratio, when the first optimal operating region is the low signal to noise ratio.

17. The apparatus of claim 14, further comprising:
means for determining an average number of data re-transmissions when the first receiver is selected to decode the one or more data transmissions; and
means for selecting the second receiver to decode the one or more data transmissions in response to the average number of data re-transmissions exceeding a threshold.

18. The apparatus of claim 14, wherein the first receiver comprises a maximum likelihood detector (MLD) receiver and the second receiver comprises a linear minimum mean square error (LMMSE) receiver.

19. The apparatus of claim 14, wherein the means for selecting the first and second receivers is operative during multiple input, multiple output (MIMO) wireless communication.

20. An apparatus configured for wireless communication, comprising:
means for determining availability of soft metrics for a data transmission;
means for obtaining an error rate for first data transmissions over a plurality of preceding subframes; and
means for selecting a receiver from a plurality of available receivers, at a mobile device, based, at least in part, on the availability of soft metrics and the error rate, wherein at least one receiver of the plurality of available receivers has different operating characteristics than at least another receiver of the plurality of available receivers.

21. The apparatus of claim 20, wherein the operating characteristics of the selected receiver includes a first optimal operating region in a high signal to noise ratio when soft metrics are not available and the error rate is below a threshold.

22. The apparatus of claim 20, wherein the operating characteristics of the selected receiver includes a second optimal operating region in a low signal to noise ratio when soft metrics are available.

23. The apparatus of claim 22, further comprising:
means for decoding a re-transmission of the data transmission by the selected receiver using the soft metrics.

24. The apparatus of claim 20, wherein the operating characteristics of the selected receiver includes a second optimal operating region in a low signal to noise ratio when the error rate exceeds a threshold.

25. The apparatus of claim 20, wherein the plurality of available receivers includes at least a maximum likelihood detector (MLD) receiver and a linear minimum mean square error (LMMSE) receiver.

26. The apparatus of claim 20, wherein the soft metrics include log likelihood ratios (LLRs).

27. A computer program product for wireless communications in a wireless network, comprising:
a non-transitory computer-readable medium having program code recorded thereon, the program code including:
program code for causing at least one computer to determining a channel quality of a channel associated with one or more data transmissions;
program code for causing at least one computer to select a first receiver to decode one or more data transmissions, wherein the first receiver is associated with higher performance at the determined channel quality than a second receiver; and
program code for causing at least one computer to select the second receiver to decode one or more data re-transmissions of the one or more data transmissions.

28. The computer program product of claim 27, wherein the first receiver has first operating characteristics associated with a first optimal operating region and the second receiver has second operating characteristics associated with a second optimal operating region, wherein the first optimal operating region is different from the second optimal operating region.

29. The computer program product of claim 28, wherein the first optimal operating region comprises one of: a high signal to noise ratio and a low signal to noise ratio; and
the second optimal operating region comprises one of the low signal to noise ratio, when the first optimal operating region is the high signal to noise ratio, and the high signal to noise ratio, when the first optimal operating region is the low signal to noise ratio.

30. The computer program product of claim 27, further comprising:
program code for causing at least one computer to determine an average number of data re-transmissions when the first receiver is selected to decode the one or more data transmissions; and
program code for causing at least one computer to select the second receiver to decode the one or more data transmissions in response to the average number of data re-transmissions exceeding a threshold.

31. The computer program product of claim 27, wherein the first receiver comprises a maximum likelihood detector (MLD) receiver and the second receiver comprises a linear minimum mean square error (LMMSE) receiver.

32. The computer program product of claim 27, wherein the program code for causing at least one computer to select the first and second receivers is executed during multiple input, multiple output (MIMO) wireless communication.

33. A computer program product for wireless communications in a wireless network, comprising:
a non-transitory computer-readable medium having program code recorded thereon, the program code including:
program code for causing at least one computer to determine availability of soft metrics for a data transmission;
program code for causing at least one computer to obtain an error rate for first data transmissions over a plurality of preceding subframes; and
program code for causing at least one computer to select a receiver from a plurality of available receivers, at a mobile device, based, at least in part, on the availability of soft metrics and the error rate, wherein at least one receiver of the plurality of available receivers has different operating characteristics than at least another receiver of the plurality of available receivers.

34. The computer program product of claim 33, wherein the operating characteristics of the selected receiver includes a first optimal operating region in a high signal to noise ratio when soft metrics are not available and the error rate is below a threshold.

35. The computer program product of claim 33, wherein the operating characteristics of the selected receiver includes a second optimal operating region in a low signal to noise ratio when soft metrics are available.

36. The computer program product of claim 35, further comprising:
program code for causing at least one computer to decode a re-transmission of the data transmission by the selected receiver using the soft metrics.

37. The computer program product of claim 33, wherein the operating characteristics of the selected receiver includes a second optimal operating region in a low signal to noise ratio when the error rate exceeds a threshold.

38. The computer program product of claim 33, wherein the plurality of available receivers includes at least a maximum likelihood detector (MLD) receiver and a linear minimum mean square error (LMMSE) receiver.

39. The computer program product of claim 33, wherein the soft metrics include log likelihood ratios (LLRs).

40. An apparatus configured for wireless communication, the apparatus comprising:
at least one processor; and
a memory coupled to the at least one processor,
wherein the at least one processor is configured:
to determining a channel quality of a channel associated with one or more data transmissions;
to select a first receiver to decode one or more data transmissions, wherein the first receiver is associated with higher performance at the determined channel quality than a second receiver; and
to select the second receiver to decode one or more data re-transmissions of the one or more data transmissions.

41. The apparatus of claim 40, wherein the first receiver has first operating characteristics associated with a first optimal operating region and the second receiver has second operating characteristics associated with a second optimal operating region, wherein the first optimal operating region is different from the second optimal operating region.

42. The apparatus of claim 41, wherein the first optimal operating region comprises one of: a high signal to noise ratio and a low signal to noise ratio; and
the second optimal operating region comprises one of the low signal to noise ratio, when the first optimal operating region is the high signal to noise ratio, and the high signal to noise ratio, when the first optimal operating region is the low signal to noise ratio.

43. The apparatus of claim 40, wherein the at least one processor is further configured:
to determine an average number of data re-transmissions when the first receiver is selected to decode the one or more data transmissions; and
to select the second receiver to decode the one or more data transmissions in response to the average number of data re-transmissions exceeding a threshold.

44. The apparatus of claim 40, wherein the first receiver comprises a maximum likelihood detector (MLD) receiver and the second receiver comprises a linear minimum mean square error (LMMSE) receiver.

45. The apparatus of claim 40, wherein the configuration of the at least one processor to select the first and second receivers is operative during multiple input, multiple output (MIMO) wireless communication.

46. An apparatus configured for wireless communication, the apparatus comprising:
at least one processor; and
a memory coupled to the at least one processor,
wherein the at least one processor is configured:
to determine availability of soft metrics for a data transmission;
to obtain an error rate for first data transmissions over a plurality of preceding subframes; and
to select a receiver from a plurality of available receivers, at a mobile device, based, at least in part, on the availability of soft metrics and the error rate, wherein at least one receiver of the plurality of available receivers has different operating characteristics than at least another receiver of the plurality of available receivers.

47. The apparatus of claim 46, wherein the operating characteristics of the selected receiver includes a first optimal operating region in a high signal to noise ratio when soft metrics are not available and the error rate is below a threshold.

48. The apparatus of claim 46, wherein the operating characteristics of the selected receiver includes a second optimal operating region in a low signal to noise ratio when soft metrics are available.

49. The apparatus of claim 48, wherein the at least one processor is further configured:
to decode a re-transmission of the data transmission by the selected receiver using the soft metrics.

50. The apparatus of claim 46, wherein the operating characteristics of the selected receiver includes a second optimal operating region in a low signal to noise ratio when the error rate exceeds a threshold.

51. The apparatus of claim 46, wherein the plurality of available receivers includes at least a maximum likelihood detector (MLD) receiver and a linear minimum mean square error (LMMSE) receiver.

52. The apparatus of claim 46, wherein the soft metrics include log likelihood ratios (LLRs).
